(19) United States
(12) Patent Application Publication
(10) Pub. No.: US 2020/0005675 A1
(43) Pub. Date: Jan. 2, 2020

(54) TOURNIQUET TRAINING DEVICE

(71) Applicant: Jeffrey James Quail, St. Andrews (CA)

(72) Inventor: Jeffrey James Quail, St. Andrews (CA)

(21) Appl. No.: 16/567,690

(22) Filed: Sep. 11, 2019

Related U.S. Application Data
(63) Continuation of application No. 15/402,907, filed on Jan. 10, 2017.
(60) Provisional application No. 62/263,691, filed on Dec. 6, 2015.

(51) Int. Cl. G09B 23/28

(52) U.S. Cl. CPC G09B 23/28

(57) ABSTRACT

A training device includes a band of material for support about a limb of a user training to apply a tourniquet. Pressure sensing elements are supported on the band at spaced positions about the limb. The user applies the tourniquet about the limb with the pressure sensing elements between the limb and the tourniquet so as to generate a pressure signal representative of a pressure level applied by the tourniquet to the limb of the user. A controller coupled to the pressure sensing elements changes the condition of a sensory feedback device carried on the user when receiving a pressure signal exceeding a lower pressure limit. The sensory feedback device may be a shocking device which is initially activated to intermittently shock the user until the user applies the tourniquet with sufficient pressure to overcome the lower pressure limit to inactivate the shocking of the user.

This application is a continuation of U.S. patent application Ser. No. 15/402,907, filed Jan. 10, 2017, and claims the benefit under 35 U.S.C. 119(e) of U.S. provisional application Ser. No. 62/263,691, filed Dec. 6, 2015.

### FIELD OF THE INVENTION

The present invention relates to a training device to train users to properly apply a tourniquet, and more particularly, the present invention relates to a tourniquet training device which includes sensory feedback, for example a shocking device, to train the user under realistic physiological and psychological conditions.

### BACKGROUND

The mayo clinic reports that retrospective studies have revealed that the leading cause of preventable death among American casualties in Vietnam was exsanguination from extremity wounds. In the first five years of the Iraq and Afghanistan conflict, exsanguination from extremity wounds accounted for 7.8% of preventable deaths. The tourniquet is the quickest, easiest and most cost-effective means of immediate trauma care in the field.

The importance of creating stress during training can't be understated. When an individual enters an acute stress state the activation of the Sympathetic Nervous System releases a plethora of hormones are released into the blood stream that results in physiological and psychological changes. These changes can have a detrimental effect on performance. Cognitive distortions can lead to impaired decision making and vasoconstriction can hamper the ability to perform fine and complex motor skills. Failure to train in an environment that replicates real world conditions, including placing stress on the soldier will not adequately prepare them to perform in real world conditions.

### SUMMARY OF THE INVENTION

According to one aspect of the invention there is provided a tourniquet training device for use in training a user to apply a tourniquet to a limb of the user, the training device comprising:

a pressure sensor arranged to be supported on the limb of the user between the limb and the tourniquet and to generate a pressure signal representative of pressure level applied by the tourniquet to the limb of the user;

a sensory feedback device arranged to be carried on the limb of the user and to be operable between an active condition providing sensory feedback to the user and an inactive condition in which the sensory feedback to the user is deactivated;

a controller operatively associated with the pressure sensor and the sensory feedback device so as to be arranged to change the condition of the sensory feedback device responsive to a pressure signal received from the pressure sensor which represents a pressure level which exceeds a lower pressure limit of the controller.

According to a second aspect of the present invention there is provided a method of applying a tourniquet about the limb of a user comprising:

providing a training device which is separate from tourniquet, the training device comprising (i) a pressure sensor arranged to generate a pressure signal representative of an applied pressure to the pressure sensor, (ii) a sensory feedback device operable between an active condition providing sensory feedback to the user and an inactive condition in which the sensory feedback to the user is deactivated, and (iii) a controller arranged to change the condition of the sensory feedback device responsive to a pressure signal received from the pressure sensor which represents a pressure level which exceeds a lower pressure limit of the controller;

supporting the pressure sensor and the sensory feedback device of the training device on the limb of the user;

applying the tourniquet about the limb of the user to apply pressure about the limb of the user subsequently to the pressure sensor being supported on the limb of the user such that (i) the pressure sensor is received between the limb and the tourniquet and (ii) the pressure sensor generates the pressure signal to be representative of the pressure level applied by the tourniquet about the limb of the user; and

using the controller to change the condition of the sensory feedback device when the pressure signal received from the pressure sensor exceeds the lower pressure limit of the controller.

The reality based tourniquet training device is designed to assist in recreating real world conditions when testing or training the soldier to self care utilizing a tourniquet device for extremity injuries.

The tourniquet training device is designed to fit around the extremities of either the arms and/or legs and will deliver a safe, localized electrical shock when activated through various triggering methods such as a simple RF signal. The device can be integrated with current force on force training systems such as M.I.L.E.S. systems or the Stressvest®. The sensory feedback device, for example a shocking device, is coupled to a pressure sensing device that is secured to the limb above the shocking device. The pressure sensing device is strategically placed over the area on the extremity that would be considered the optimal location for the application of a tourniquet.

When using a shocking device, activation of the shocking device will deliver random electrical pulses designed to simulate an injury to the related limb. The pain from the electrical impulses will create acute stress in the soldier to simulate real world battle conditions. Under these conditions, the soldier will be required to identify the simulated injury, identify the appropriate emergency trauma self-care, remove their combat tourniquet, and then properly apply the tourniquet.

In preferred embodiments, immediately upon activation of the reality based tourniquet training device, a visible digital timer will start. Proper application of the tourniquet is measured by the pressure sensors. When the tourniquet applies the optimal pressure for the desired limb, it will stop the shocking device from delivering anymore shocks. It will also stop the timer, if used, to capture the time it took from point of injury until properly applying a tourniquet.

Since pressure under a tourniquet is not evenly distributed, it is important to ensure that the sensors are strategically placed to allow for this variance in force.

An upper level of force can also be established as over compression has been show to lead to muscle and nerve damage (Noordin, Shahryar; McEwen, James A.; Kragh, John F. (2009). “Current Concepts Review: Surgical Tourniquets in Orthopaedics”. Journal of Bone and Joint Surgery (JBJS) 91 (12): 2958-67). If the threshold for the upper level of force is reached, the device will provide feedback through either an audio warning, light warning or restarting the shocking device.

The pressure sensor preferably comprises an array of pressure sensing elements supported spaced apart from one another in a row so as to be arranged to be supported on the user at circumferentially spaced apart locations about the limb of the user.

The tourniquet training device preferably further comprises a band of material arranged to be secured about the limb of the user, the pressure sensing elements being supported spaced apart from one another on the band of material.

The sensory feedback device is preferably also supported on the band of material.

The controller may also be arranged to activate an alarm condition when the pressure signal from the pressure sensor and received by the controller represents a pressure level which exceeds an upper pressure limit of the controller.

Preferably the controller is also arranged to be carried on the user.

The controller may include a timer for measuring a duration until the controller receives the pressure signal from the pressure sensor which represents the pressure level which exceeds the lower pressure limit of the controller, and a display on a housing of the controller for displaying said duration in real time.

When the controller is arranged to inactivate the sensory feedback device in response to receiving the pressure signal from the pressure sensor which represents the pressure level which exceeds the lower pressure limit of the controller, preferably the controller includes a timer for measuring a duration between an activation of the sensory feedback device and an inactivation of the sensory feedback device when the controller receives the pressure signal from the pressure sensor which represents the pressure level which exceeds the lower pressure limit of the controller.

The controller may be further arranged to transmit pressure data and condition changes of the sensory feedback device wirelessly to a remote computer device.

The tourniquet training device may include a remote activation device arranged to generate a wireless activation signal, in which the controller includes a receiver for receiving the wireless activation signal and in which the controller is arranged to change a condition of the sensory feedback device responsive to receipt of the wireless activation signal.

Alternatively, when the tourniquet training device is used with a combat simulation device arranged to (i) be carried by the user, (ii) determine when the user has been hit within a simulated combat environment, and (iii) generate an activation signal responsive to the determination, the controller is preferably operatively associated with the combat simulation device so as to be arranged to change a condition of the sensory feedback device responsive to receipt of the activation signal from the combat simulation device.

The sensory feedback device may include an electrical shocking element which is arranged to deliver a continuing series of electrical shocks to the user in the active condition of the sensory feedback device. In this instance, the controller is preferably arranged to change the condition of the sensory feedback device from the active condition to the inactive condition responsive to the pressure signal received from the pressure sensor which represents the pressure level which exceeds the lower pressure limit of the controller. When the controller includes an upper pressure limit which represents a greater pressure than the lower pressure limit, the controller is arranged to change the condition of the sensory feedback device from the inactive condition to the active condition responsive to the pressure signal received from the pressure sensor which represents a pressure level which exceeds the upper pressure limit of the controller.

The sensory feedback device may include a vibrating element, in addition to or instead of the electrical shocking element, in which the vibrating element is arranged to vibrate in the active condition of the sensory feedback device.

The sensory feedback device may also include an audible alarm element, in addition to or instead of either one of the electrical shocking element and/or the vibrating element, in which the audible alarm element is arranged to emit an audible alarm in the active condition of the sensory feedback device.

### BRIEF DESCRIPTION OF THE DRAWINGS

Various embodiments of the invention will now be described in conjunction with the accompanying drawings in which:

FIG. 1 shows the device in its entirety, being worn on an arm with the RF activating device;

FIG. 2 shows the device in its entirety, being worn on an arm, with a tourniquet being applied;

FIG. 3 shows a face down view of the device, laying flat, with the controller/timer unit displayed;

FIG. 4 shows a face down view of the device, laying flat, with the fabric cover removed to show the pressure sensors, wires and electrical shocking device;

FIGS. 5A, 5B, 5C and 5D show the front view, back view, side view and exploded view respectively of the controller/timer unit; and

FIGS. 6A, 6B, and 6C show the side view, back view and exploded view respectively of the electrical shocking element.

In the drawings like characters of reference indicate corresponding parts in the different figures.

The reference numbers in the drawings designate the following features: 100 Fabric band that holds force sensing and shocking device; 110 Shock generator; 120 Velcro; 130 Force Sensors; 140 Electrodes; 150 Circuit board for shocking device; 160 Cover for shocking device; 170 Wires from shocking device; 180 Wires from force sensors; 200 Controller and timer unit; 210 Top case for controller/timer; 220 Bottom case for controller/timer; 230 Input connector; 240 Digital display for timer; 250 On/off button; 260 Circuit Board for controller/timer; 270 Wire connecting shock/sensor device with controller/timer; 280 Screws; 300 External input wire and connector; 400 Sample of external RF activator; 410 RF receiver for controller/timer; 500 Tourniquet, and 600 combat simulation device.

### DETAILED DESCRIPTION

Referring to the accompanying figures there is illustrated a tourniquet training device. The tourniquet training device is used for training a user to apply a tourniquet to one of their limbs.

The training device generally includes (i) a band 100 formed of a suitable fabric material which is arranged to be secured about the limb of the user, (ii) a pressure sensor comprising an array of pressure sensing elements 130 supported on the band 100 for generating a pressure signal representative of the pressure applied by a tourniquet to the limb of the user when the tourniquet is secured about the limb over top of the band 100, (iii) a sensory feedback device 110 also supported on the band 100 so as to be carried on the limb of the user and be operable between an active condition providing sensory feedback to the user and an inactive condition in which the sensory feedback to the user is deactivated, and (iv) a controller 200 operatively associated with the pressure sensors 130 and the sensory feedback device 110 so as to be arranged to change the condition of the sensory feedback device responsive to a pressure signal received from the pressure sensor which represents a pressure level which exceeds a lower pressure limit of the controller.

In general use, the band 100 is secured about a limb of a user at a location where an injury is to be simulated. The controller is turned on using a power button 250 which is externally accessible on the housing of the controller 200. Once powered on, the controller is in a ready state such that a radiofrequency receiver 410 supported internally within the housing of the controller 200 is ready to receive an activation signal to begin simulation of an injury to the limb of the user.

When the sensory feedback device is a shock generator 110, receipt of an activation signal causes the shock generator to begin applying a shock to the user for example as an ongoing and continuing series of intermittent and randomly applied electrical shocks which do not cause incapacitation, but which do cause discomfort and/or pain to the user to simulate the injury.

The controller also includes a timer incorporated into a circuit board 260 internally within the housing of the controller which begins measuring a duration of time from the moment the activation signal is received. The measured duration is displayed in real time through a display 240 which is connected to the internal circuit board 260 but which is mounted on the housing of the controller 200 so as to be externally visible by the user.

Once the simulated injury has begun, the user must then apply a tourniquet 500 about the band 100 such that the force sensors 130 are compressed between the tourniquet 500 and the limb of the user. The force signals generated by the force sensors are communicated to the controller 200 and are collectively used to generate a pressure signal which is representative of the overall pressure applied by the tourniquet to the limb of the user.

The pressure signal is continuously monitored by the controller and compared to limits stored on the controller including a lower pressure limit and an upper pressure limit that is greater in magnitude than the lower pressure limit. The circuit board of the controller includes a memory for storing data thereon and a processor for executing programming instructions also stored on the memory to execute the various functions of the controller. When the monitored pressure signal remains below the lower pressure limit, the sensory feedback device remains in an active condition providing sensory feedback to the user, for example shocking the user. When the monitored pressure signal is between the lower pressure limit and the upper pressure limit, the sensory feedback device is changed to the inactive condition such that sensory feedback to the user is reduced in magnitude or deactivated entirely. When the monitored pressure signal is above the upper pressure limit, the sensory feedback device is changed back to the active condition providing sensory feedback to the user, for example shocking the user.

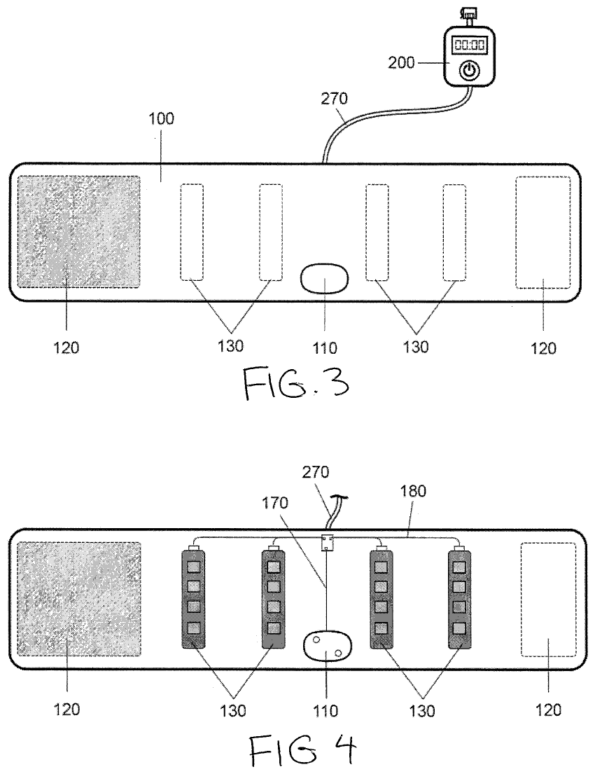

The configuration of the band 100 will now be described in further detail. The band 100 includes a first layer of fabric material shown in FIG. 4 which is elongate in a longitudinal direction between opposing ends of the band which support hook and loop fasteners 120 thereon. The individual pressure sensing elements 130 are supported on the fabric material at spaced apart positions in the longitudinal direction within a row. Each individual pressure sensing element may comprise a row of laterally spaced apart pressure sensing components such that the pressure sensing components collectively form array which are all connected in communication with the controller through a series of wires 180 supported on the band 100 which communicate through a wiring harness 270 between the band 100 and the controller 200.

The sensory feedback device 110 represented as a shock generator in the preferred embodiment, is also supported on the fabric material of the band 100 laterally offset towards one of the longitudinally extending edges of the band opposite from the connection to the wiring harness 270. The longitudinally extending edge of the band coupled to the wiring harness 270 is generally viewed as the top edge so that the sensory feedback device 110 is positioned closer to the bottom edge than the top edge. When mounting the band of material on the limb of the user, the top edge is typically positioned closer to the torso and the bottom edge so that the sensory feedback device 110 is closer to the extremity of the limb than the pressure sensor 130.

A second layer of fabric material is applied over top of the first layer fabric material, as shown in FIG. 3, so that the pressure sensor and the shock generator are contained between the layers of fabric material of the band 100.

The cooperating hook and loop fasteners 120 are supported on opposing inner and outer sides of the band 100 at the longitudinally opposing ends of the band so that the band can be wrapped about the limb of the user with the fasteners 120 at one end of the band being overlapped over the fasteners at the other end of the band when the ends of the fabric material overlap one another. The hook and loop fasteners readily permit the overall circumference of the band to be varied when securing about a limb of the user to accommodate for different limb sizes.

The sensory feedback device 110 includes an outer casing 160 receiving a circuit board 150 therein having a memory and a processor thereon for executing programming instructions stored on a memory to perform the various functions of the sensory feedback device as described herein. The circuit board 150 of the sensory feedback device 110 communicates with suitable wires 170 to the wiring harness 270 so as to be arranged to exchange signals and data with the controller 200. More particularly, an activation signal and a deactivation signal can be relayed from the controller 200 to the sensory feedback device 110 for changing the condition of the sensory feedback device to the active condition and the inactive condition respectively.

In the instance of a shock generator, two electrodes 140 protrude from one side of the circuit board and surrounding casing 160. The electrodes are arranged to be penetrated through an innermost one of the layers of fabric material of the band 100 while the casing 160 remains internal between the layers of fabric material of the band 100. More particularly, the electrodes may each include a shaft portion received through an aperture in the fabric material and an enlarged head at the free end of the shaft portion which is larger in dimension than the shaft portion and the aperture in the fabric material to serve to retain the position of the sensory feedback device 110 within the band 100. This also ensures that the head of each electrode remains exposed at the exterior of the band 100 for direct contact with the user.

The controller 200 is connected to the components of the band 100 by the wiring harness 270 which acts as a tether between the housing of the controller 200 and the band 100. The tether formed by the wiring harness 270 assists in carrying the controller on the user. The housing of the controller is formed by a top case 210 and a bottom case the 220 which can be coupled to one another using screws 280 to retain the circuit board 260 therein. An external connector 230 is supported externally of the housing of the controller but in communication with the circuit board to enable an activation signal to be received by a wired connection to the connector 230. Alternatively, a wireless activation signal may be received by the radio frequency receiver 410 connected to the circuit board 260 within the housing of the controller 200.

The training device may be used with a remote actuator 400. The remote actuator is an independent housing supporting suitable electronics therein so as to be capable of generating and transmitting the wireless activation signal when an external activation button on the housing of the remote actuator is depressed.

Alternatively, the training device may be used with a combat simulation device 600 which is also worn on the user, for example by being carried on a belt worn about the torso of the user. The combat simulation device is typically one component of a combat training system involving simulated weapons for generating simulated hits to participants of the combat training system. The combat simulation device 600 is associated with an individual participant in the combat training system upon which the combat simulation device is carried. A communication cable 300 forms a wired connection between the connector 230 on the controller 200 and the combat simulation device 600. The device 600 determines when the user upon which it is carried has been hit within a simulated combat environment of the combat training system and generates an appropriate activation signal responsive to that determination. The controller 200 is arranged to receive the activation signal from the combat simulation device 600 and change the condition of the sensory feedback device to an active condition upon receipt of the activation signal.

In either instance, a receipt of an activation signal by the controller 200 starts the timer and begins shocking the user until a tourniquet is applied with sufficient pressure that the pressure sensor generates a pressure signal which exceeds the lower pressure limit of the controller 200.

In other instances, when the sensory feedback device comprises a vibration module, receipt of an activation signal results in activation of the timer and activation of the vibration module from the inactive condition to the active condition thereof for applying a vibration to the user. The vibration will cease when the pressure signal exceeds the lower pressure limit to return the vibration module to the inactive condition.

Similarly, when the sensory feedback device comprises an audible alarm element, the sensory feedback device emits an audible alarm in the active condition which will cease only when the pressure signal exceeds the lower pressure limit to return the audible alarm element to the inactive condition.

As described above, the tourniquet training device includes several distinguishing features noted in the following.

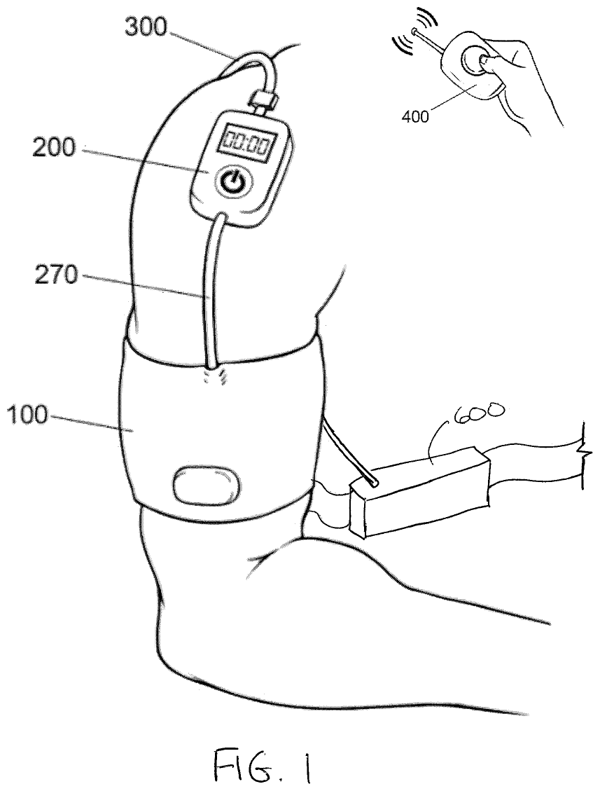

FIG. 1 shows the view of the tourniquet training device being worn on the arm of an individual from a profile view. It displays the external input wire and connector 300, connected to the controller/timer unit 200 and leading over the shoulder to presumably a hardwired device 600 designed to send an input. The controller/timer 200 is connected by wire 270 to the shock generator and sensors housed in the fabric armband 100. An RF transmitter 400 is displayed to provide an example of another method of activation.

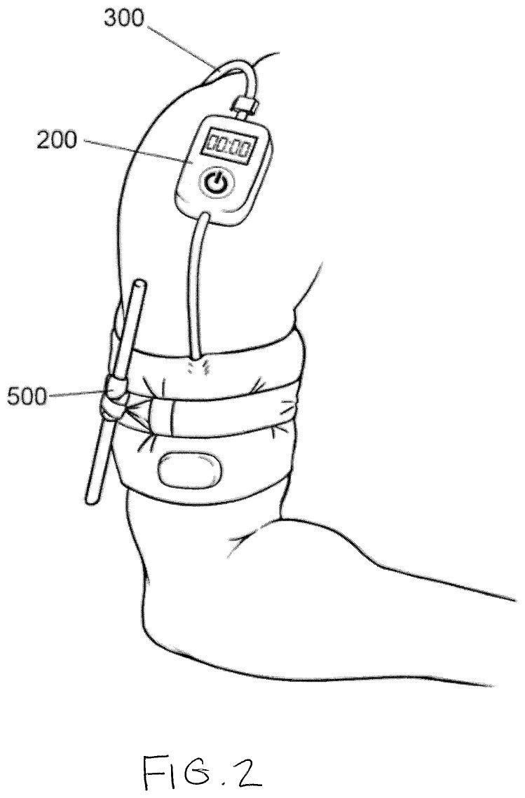

FIG. 2 shows the view of the tourniquet training device being worn on the arm of an individual from a profile view. It displays the external input wire and connector 300, connected to the controller/timer unit 200 and leading over the shoulder to presumably a hardwired device designed to send an input. The controller/timer 200 is connected by wire 270 to the shock generator and sensors housed in the fabric armband 100. An actual working tourniquet 500 is shown as it would be applied to the training device.

FIG. 3 shows the outstretched fabric 100 with the device facing downwards in the manner it would face towards the arm if attached. Velcro 120 is shown at each end of the device to allow it to be secured to the arm and adjusted to fit different size participants. Several pockets are indicated and would house the pressure sensors 130. The hard case of the shock generator 110 can be viewed from this perspective.

FIG. 4 shows the outstretched fabric 100 with the device facing downwards in the manner it would face towards the arm if attached. The outer fabric is removed revealing the position of the force sensors 130. Wires 180 lead from the force sensors 130 through the wire 270 to the controller/timer 200. A wire 170 can also be viewed leading from the shock generator 110 through the wire 270 to the controller/timer 200.

FIGS. 5A, 5B, 5C and 5D show the front view, back view, side view and exploded view respectively of the controller 200. The back view shows a hard case 220 that is sealed with screws 280 and the input connector 230. The front view shows the digital display 240 that displays elapsed time. A power on/off button is featured in the front. The side view displays how the front case 210 and rear case 220 fit together. The exploded view reveals the circuit board with battery 260 that has the digital display 240, the power on/off button 250 and the RF receiver for the controller/timer 410.

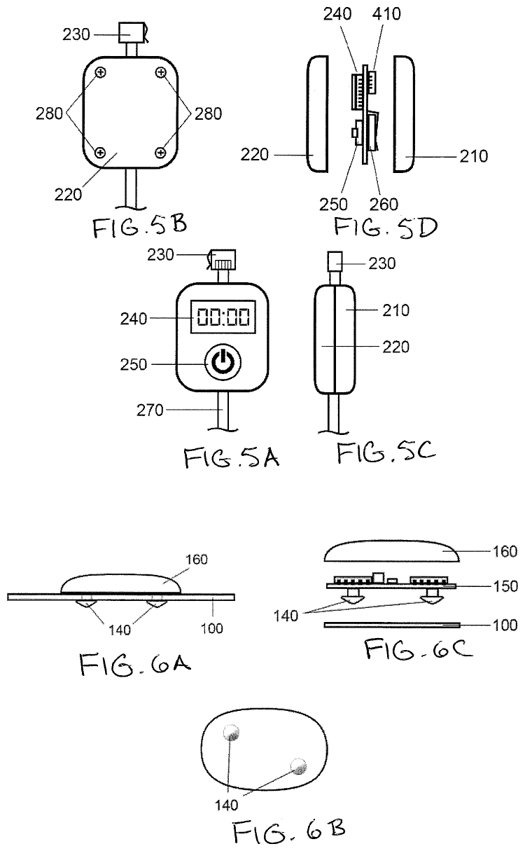

FIGS. 6A, 6B, and 6C show a side view, bottom view and exploded view respectively of the shock generator 110. The side view reveals that the electrodes 140 are used to trap the fabric 100, between the electrodes and the circuit board 150 and outer casing 160. The bottom view displays how the electrodes 140 are spaced apart from each other. The configuration and assembly of the electrical components and the mechanical assembly will be well known to those with ordinary skill in electronic and mechanical arts.

The operation of the tourniquet training device will now be described in further detail. A battery is placed in the controller/timer 200. The controller/timer 200 is either left in a stand-alone state allowing for RF triggering or is coupled to a M.I.L.E.S. vest or Stressvest or some similar receiver system by connecting with the external input wire and connector 300.

The fabric band that holds the force sensing and shocking device 100 is placed over the desired limb of the student. The shocking device 110 should be placed lower on the extremity than the pressure sensing pad 130. This mimics the injury occurring beneath the location that the tourniquet would need to be applied.

The device is powered on by depressing the on/off button 250 and immediately moves into a ready state. The device will also be set for sensing optimal pressure for the location the device is attached. As soon as a trigger input is received through the input wire 300 or from receiving an RF trigger signal the shocking device will immediately deliver a shock and start the digital timer 240. The shocking device will then continue to randomly deliver shocks.

The soldier will experience the shocks to the affected limb and recognize the need to deliver self-care for the simulated trauma. They will move to a safe position in the training environment, remove their tourniquet 500 and apply it overtop of the affected area. The pressure/force sensing pad 130 will measure the pressure being applied by the tourniquet 500. When the desired pressure has been reached, a processer will send a signal to shut down the shocking device and stop the digital timer. If the soldier continues to apply pressure to a level that is deemed a risk of causing a compression injury, the processor will cause an alert to be signaled. This may be audible, visible or the restarting of the shocking device.

When the device is shut off by depressing the on/off button 250, it resets and the timer moves back to a zero state when the device is turned on again.

In alternative embodiments, different materials, sizes and textures can be used for all components. The device can be integrated into full body protection suits. Various types of force sensors may be used. For example, in lieu of electronic force sensors, hydraulic tubing with force sensor or air lines with force sensors could be used or any combination. The pressure/force sensing device could be made completely out of injection foam with sensors embedded. Other modes in lieu of shock can be used such as vibration, audio signal, visual signal or other stimulus. Feedback such as pressure, time, etc. could be transmitted wirelessly to a remote display that may be stand alone, a computer, tablet, smart phone, etc. Precise details of force applications can be recorded and displayed.

Since various modifications can be made in my invention as herein above described, and many apparently widely different embodiments of same made, it is intended that all matter contained in the accompanying specification shall be interpreted as illustrative only and not in a limiting sense.

1. A method of applying a tourniquet about the limb of a user comprising:
providing a training device which is separate from tourniquet, the training device comprising (i) a pressure sensor arranged to generate a pressure signal representative of an applied pressure to the pressure sensor, (ii) a sensory feedback device operable between an active condition providing sensory feedback to the user and an inactive condition in which the sensory feedback to the user is deactivated, and (iii) a controller arranged to change the condition of the sensory feedback device responsive to a pressure signal received from the pressure sensor which represents a pressure level which exceeds a lower pressure limit of the controller;
supporting the pressure sensor and the sensory feedback device of the training device on the limb of the user;
applying the tourniquet about the limb of the user to apply pressure about the limb of the user subsequently to the pressure sensor being supported on the limb of the user such that (i) the pressure sensor is received between the limb and the tourniquet and (ii) the pressure sensor generates the pressure signal to be representative of the pressure level applied by the tourniquet about the limb of the user; and
using the controller to change the condition of the sensory feedback device when the pressure signal received from the pressure sensor exceeds the lower pressure limit of the controller.

2. The method according to claim 1 wherein the pressure sensor comprises an array of pressure sensing elements supported spaced apart from one another in a row, the method comprising supporting the array of pressure sensing elements on the user so that the pressure sensing elements are circumferentially spaced apart about the limb of the user.

3. The method according to claim 2 wherein the training device includes a band of material supporting the pressure sensing elements spaced apart from one another thereon, the method comprising securing the band of material about the limb of the user independently of the tourniquet.

4. The method according to claim 3 wherein the sensory feedback device is supported on the band of material.

5. The method according to claim 1 including using the controller to activate an alarm condition when the pressure signal from the pressure sensor represents a pressure level which exceeds an upper pressure limit of the controller.

6. The method according to claim 1 including supporting the controller on the user.

7. The method according to claim 1 wherein the controller includes a display on a housing of the controller and a timer, the method including:
using the timer for measuring a duration until the controller receives the pressure signal from the pressure sensor which represents the pressure level which exceeds the lower pressure limit of the controller, and
displaying said duration in real time on the display of the controller.

8. The method according to claim 1 wherein the controller includes a timer, the method including:
using the controller to inactivate the sensory feedback device in response to receiving the pressure signal from the pressure sensor which represents the pressure level which exceeds the lower pressure limit of the controller; and
using the timer to measuring a duration between an activation of the sensory feedback device and an inactivation of the sensory feedback device when the controller receives the pressure signal from the pressure sensor which represents the pressure level which exceeds the lower pressure limit of the controller.

9. The method according to claim 1 including wirelessly transmitting pressure data and condition changes of the sensory feedback device from the controller to a remote computer device.

10. The method according to claim 1 wherein the training device includes a remote activation device arranged to generate a wireless activation signal and the controller includes a receiver for receiving the wireless activation signal, the method including:
using the remote activation device to generate the wireless activation signal, and
using the controller to change a condition of the sensory feedback device responsive to receipt of the wireless activation signal from the remote activation device.

11. The method according to claim 1 including:
providing a combat simulation device arranged to (i) be carried by the user, (ii) determine when the user has been hit within a simulated combat environment, and (iii) generate an activation signal responsive to the determination;
using the combat simulation device to generate the activation signal; and
using the controller to change a condition of the sensory feedback device responsive to receipt of the activation signal from the combat simulation device.

12. The method according to claim 1 wherein the sensory feedback device includes an electrical shocking element, the method including using the electrical shocking element to deliver a continuing series of electrical shocks to the user in the active condition of the sensory feedback device.

13. The method according to claim 12 including using the controller to change the condition of the sensory feedback device from the active condition to the inactive condition responsive to the pressure signal received from the pressure sensor which represents the pressure level which exceeds the lower pressure limit of the controller.

14. The method according to claim 12 wherein the controller includes an upper pressure limit which represents a greater pressure than the lower pressure limit, the method including using the controller to change the condition of the sensory feedback device from the inactive condition to the active condition responsive to the pressure signal received from the pressure sensor which represents a pressure level which exceeds the upper pressure limit of the controller.

15. The method according to claim 1 wherein the sensory feedback device includes a vibrating element, the method including using the vibrating element to vibrate in the active condition of the sensory feedback device.

16. The method according to claim 1 wherein the sensory feedback device includes an audible alarm element, the method including using the alarm element to emit an audible alarm in the active condition of the sensory feedback device.
